(19) United States
(12) Patent Application Publication
(10) Pub. No.: US 2017/0078136 A1
(43) Pub. Date: Mar. 16, 2017

(54) ENTITY ACKNOWLEDGEMENTS IN SOCIAL NETWORKING

(71) Applicant: Google Inc., (US)

(72) Inventors: David Mark Byttow, Mountain View, CA (US); Pavan Desikan, Palo Alto, CA (US); Daniel Dulitz, Mountain View, CA (US); Gregory Matthew Marra, San Francisco, CA (US); Christian Oestlien, New York, NY (US); Davi del Castro Reis, Belo Horizonte (BR)

(73) Assignee: Google Inc., Mountain View, CA (US)

(21) Appl. No.: 13/668,189

(22) Filed: Nov. 2, 2012

Related U.S. Application Data
(60) Provisional application No. 61/556,168, filed on Nov. 4, 2011.

(51) Int. Cl. G06F 15/16

(52) U.S. Cl. CPC H04L 29/12037; H04L 29/12933

(57) ABSTRACT

In one aspect, a method includes verifying a first link in a first resource associated with an entity. The first resource is provided through a social networking service. The first link links to a second resource associated with the entity. The method also includes verifying a second link in the second resource. The second link links to the first resource. Additionally, the method includes receiving acknowledgments of the first resource and receiving acknowledgments of the second resource. The method further includes combining the acknowledgments of the first resource and acknowledgments of the second resource. And the method includes providing the combination for display on the first webpage or the second webpage. Receipt of an acknowledgement from a user who is a member of the social networking website does not add the entity to any access control list associated with the user at the social networking website.

### RELATED APPLICATION

This application claims priority to and the benefit of U.S. Provisional Application No. 61/556,168, bearing the same title, which was filed on Nov. 4, 2011, and whose disclosure is incorporated herein by reference.

### BACKGROUND

Some search engine and social networking websites provide a widget in the form of a graphical user interface (GUI) button to webmasters for inclusion in a webpage (e.g., a webpage which can be accessed with a Uniform Resource Locator or URL) on a website external to the search engine website or the social networking website. Among other things, this GUI button allows a user to interact with a webpage by publicly recommending the webpage to other users by clicking on the button.

### SUMMARY

In an example embodiment, a processor-executed method is described for associating user acknowledgements with an entity. According to the method, software at a social networking website verifies a hyperlink in an entity webpage displayed by a social networking website. The hyperlink links to an external entity webpage. The software also verifies a hyperlink in the external entity webpage. This hyperlink links to the entity webpage displayed by the social networking website. The software receives user acknowledgements from users viewing the entity webpage on the social networking website. And the software receives user acknowledgements from users viewing the external entity webpage. The software then calculates a sum of any user acknowledgements of the social-network entity webpage and any user acknowledgements of the external entity webpage. And the software causes the sum to be displayed on both the social-network entity webpage and the external entity webpage. Receipt of a user acknowledgement from a user who is a member of the social networking website does not add the entity to any access control list associated with the user at the social networking website.

This and other embodiments can include one or more of the following features. The acknowledgement can be received through a graphical user interface (GUI) button on the webpage. The acknowledgement can be confirmed with a GUI dialog box indicating that a user is acknowledging the entity, not the webpage being viewed by the user. Verifying a link can include verifying that the link is operational and that the webpage linked by the link is owned or controlled by the entity. Further, the software might display an image associated with a user who makes an acknowledgement, where the image is displayed on the first webpage, the second webpage, or both webpages. And the software might provide the sum for display in any search results that include the first webpage or the second webpage.

In another example embodiment, an apparatus is described, namely, a computer-readable storage medium that persistently stores a program for associating user acknowledgements with an entity. The program might be part of the software at a social networking website. The program verifies a hyperlink in an entity webpage displayed by a social networking website. The hyperlink links to an external entity webpage. The program also verifies a hyperlink in the external entity webpage. This hyperlink links to the entity webpage displayed by the social networking website. The program receives user acknowledgements from users viewing the entity webpage on the social networking website. And the program receives user acknowledgements from users viewing the external entity webpage. The program then calculates a sum of any user acknowledgements of the social-network entity webpage and any user acknowledgements of the external entity webpage. And the program causes the sum to be displayed on both the social-network entity webpage and the external entity webpage. Receipt of a user acknowledgement from a user who is a member of the social networking website does not add the entity to any access control list associated with the user at the social networking website.

Again, this and other embodiments can include one or more of the following features. The acknowledgement can be received through a graphical user interface (GUI) button on the webpage. The acknowledgement can be confirmed with a GUI dialog box indicating that a user is acknowledging the entity, not the webpage being viewed by the user. Verifying a link can include verifying that the link is operational and that the webpage linked by the link is owned or controlled by the entity. Further, the program might display an image associated with a user who makes an acknowledgement, where the image is displayed on the first webpage, the second webpage, or both webpages. And the program might provide the sum for display in any search results that include the first webpage or the second webpage.

In another example embodiment, another processor-executed method is described for associating user acknowledgements with an entity. According to the method, software at a social networking website verifies a hyperlink in an entity webpage displayed by a social networking website. The hyperlink links to an external entity webpage. The software also verifies a hyperlink in the external entity webpage. This hyperlink links to the entity webpage displayed by the social networking website. The software receives user acknowledgements from users viewing the entity webpage on the social networking website. The software also receives user acknowledgements from users viewing the external entity webpage. And the software receives user acknowledgements associated with an ad relating to the entity. The software then calculates a sum of any user acknowledgements of the social-network entity webpage, any user acknowledgements of the external entity webpage, and any user acknowledgements associated with the ad. And the software causes the sum to be displayed on the social-network entity webpage, on the external entity webpage, and proximate to the ad. Receipt of a user acknowledgement from a user who is a member of the social networking website does not add the entity to any access control list associated with the user at the social networking website.

This and other embodiments can include one or more of the following features. The acknowledgement can be received through a graphical user interface (GUI) button on the webpage. The acknowledgement can be confirmed with a GUI dialog box indicating that a user is acknowledging the entity, not the webpage being viewed by the user. Verifying a link can include verifying that the link is operational and that the webpage linked by the link is owned or controlled by the entity. Further, the software might display an image associated with a user who makes an acknowledgement, where the image is displayed on the first webpage, the second webpage, or both webpages. And the software might provide the combination for display in any search results that include the first webpage or the second webpage.

Other aspects and advantages of the disclosures will become apparent from the following detailed description, taken in conjunction with the accompanying drawings, which illustrate by way of example the principles of the disclosures.

### BRIEF DESCRIPTION OF THE DRAWINGS

FIG. 1A is a network diagram, in accordance with an example embodiment.

FIG. 1B is an architectural diagram, in accordance with an example embodiment.

FIG. 2 is a software diagram, in accordance with an example embodiment.

FIG. 3 is a flowchart diagram of a process for displaying a user-acknowledgement count on an entity webpage displayed by a social networking website and an external entity webpage, in accordance with an example embodiment.

FIG. 4 is a flowchart diagram of a process for displaying a user-acknowledgement count in search results, in accordance with an example embodiment.

FIG. 5 is a flowchart diagram of a process for displaying a user-acknowledgement count proximate to an ad, in accordance with an example embodiment.

FIG. 6 shows an entity webpage displayed by a social networking website, in accordance with an example embodiment.

### DETAILED DESCRIPTION

In the following description, numerous specific details are set forth in order to provide a thorough understanding of the embodiments. However, the example embodiments may be practiced without some of these specific details.

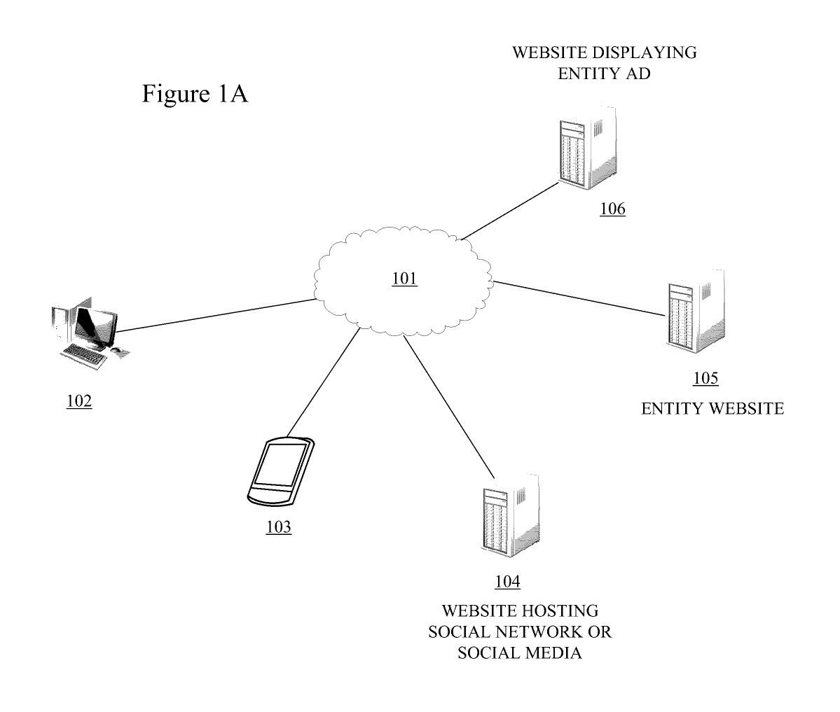

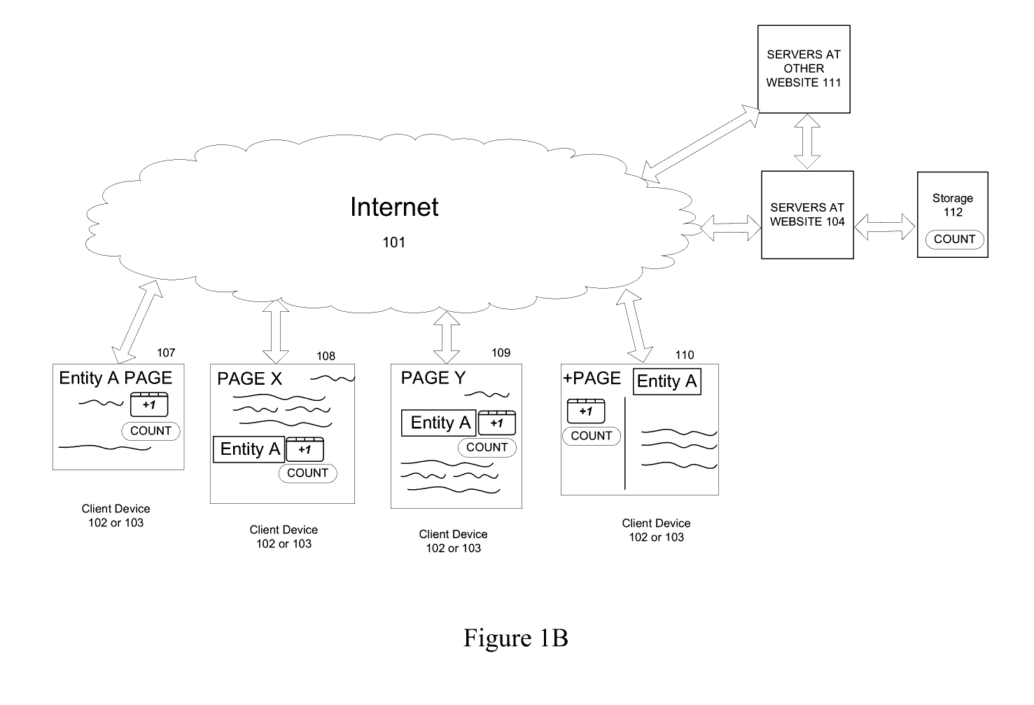

FIG. 1A is a network diagram, in accordance with an example embodiment. As depicted in this figure, two client devices (102 and 103) are connected to a network 101, e.g., a wide area network (WAN) such as the Internet. Also connected to network 101 is: (1) a website 104 hosting a social network (e.g., with a social graph controlled by access control lists or ACLs) or social media (e.g., image, sound, and/or video files along with textual comments); (2) an entity website 105 (e.g., a website for an online retailer); and (3) a website 106 that displays an entity ad (e.g., an email website). In an example embodiment, some or all of the connections to network 101 might be wireless in whole or in part. This might also be true of the connections within network 101.

Client device 102 might be a relatively non-mobile computing device such as a desktop or it might be a laptop. As such, its hardware might include one or more microprocessors, along with volatile and persistent storage in the form of RAM or a hard disk, respectively. The software running on client device 102 might include: (1) an operating system that runs on the hardware; and (2) a web browser, that runs on or is part of the operating system.

Client device 103 might be a mobile computing device such as a smartphone or a tablet computer. Its hardware might include one or more microprocessors, along with volatile and persistent storage in the form of RAM and flash memory (e.g., microSD), respectively. The software running on client device 103 might include: (1) an operating system that runs on the hardware; and (2) a web browser or web-browsing app that runs on or is part of the operating system.

In an example embodiment, website 104 might be composed of a number of servers connected by a network (e.g., a local area network (LAN) or a WAN) to each other in a cluster or other distributed system which might run: (1) an operating system , running on hardware that might include one or more microprocessors, along with volatile and persistent storage in the form of RAM or a hard disk, respectively; (2) website software (e.g., web-server software, database software, etc.); and/or (3) distributed-computing and/or cloud software. The servers might also be connected (e.g., by a storage area network (SAN)) to persistent storage that might include a redundant array of independent disks (RAID). In an alternative example embodiment, the servers in website 104 and/or their volatile and persistent storage might be hosted wholly or partially off-site in the cloud, e.g., as a platform-as-a-service (PaaS) or an infrastructure-as-a-service (IaaS). The servers at websites 105 and 106 might make use of similar hardware, software, and/or resource (e.g., persistent storage) configurations.

In an example embodiment, users of client devices 102 and 103 might use browsers to communicate with the software running on the servers at website 104. Further, persistent storage at website 104 might be used to store data related to user acknowledgements as described below, along with other webpage data and social networking data (e.g., profile data, stream data, access control lists or ACLs, etc.). And in an example embodiment, software running on one or more of the servers at website 104 might execute some or all of the process operations described below.

FIG. 1B is an architectural diagram, in accordance with an example embodiment. As depicted in this figure, one or more client devices (102 or 103) are displaying webpages 107, 108, 109, and 110. In an example embodiment, each of these webpages might be displayed by the same client device, e.g., using tabs in a web browser. In an alternative example embodiment, each of these webpages might be displayed on a different client device. Each of the webpages 107, 108, 109, and 110 includes a count associated with user acknowledgements, as described in further detail below.

In an example embodiment, webpage 107 might be a webpage displayed by or on behalf of an entity (e.g., an online retailer). Webpages 108 and 109 might be webpages that are not displayed by or on behalf of the entity, but which nonetheless include content related to the entity, e.g., advertising content in the form of an ad. Webpage 110 might be a webpage that is (1) associated with the entity and (2) that is displayed by a social networking website, e.g., website 104.

In an example embodiment, software running on website 104 might (a) sum user indications of acknowledgment, endorsement, disapproval, rating, sharing, etc. (such as a GUI-button click) from webpages 107, 108, 109, and 110, (b) transmit the sum to the webpages (e.g., using HTML and/or JavaScript) over the Internet 101, and (c) store the sum for later updating in persistent storage 112, using an internal network (e.g., a storage area network or SAN). In an example embodiment, website 104 might receive the user indications over the Internet 101 directly from software (e.g., a web browser or web-browser plugin) running on the client device or client devices displaying the webpages. In an alternative example embodiment, website 104 might receive the user indications over the Internet 101 or over an internal network (e.g., a local area network or LAN) in aggregated or disaggregated form from software running on another website 111 (e.g., a search engine website).

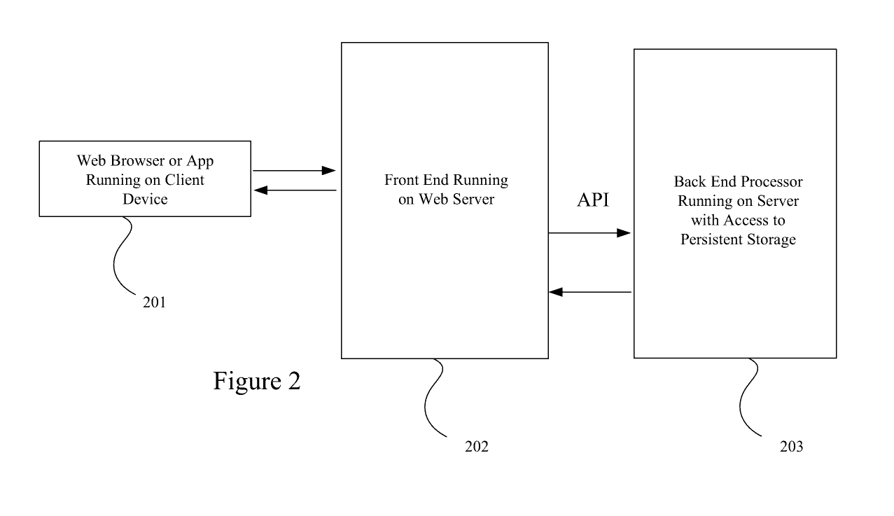

FIG. 2 is a software diagram, in accordance with an example embodiment. As depicted in this diagram, a web browser or app 201 running on a client device (e.g., personal computer 102 or mobile device 103) communicates with a frontend 202 running on a web server at a social networking website. In an example embodiment, web browser or app 201 might display a webpage (e.g., served up by server 106 or server 108) that contains a GUI button (e.g., a “+1” button). In an example embodiment, the GUI button might be associated with a GUI tooltip that contains a textual message (e.g., “Click to +1”). If a user clicks on such a GUI button in web browser or app 201, the click might be communicated to the front end 202 and might cause all or part of the webpage to be redrawn to reflect the click (e.g., the GUI button might change color). Additionally, the GUI tooltip associated with the button might change its textual message (e.g., “Click to remove your +1.”)

Further, as depicted in FIG. 2, frontend 202 communicates with a backend processor 203 (which is software and is also running on a server), using an Application Programming Interface (API). In an example embodiment, the backend processor 203 might enforce policies related to the social networking website, e.g., a policies which distinguish between (1) users who are real persons and (2) users who are entities who have promotional interests that are adverse to the privacy interests of users who are real persons. Also, in an example embodiment, backend processor 203 might have access to persistent storage (e.g., persistent storage 105) which stores data related to both users who are real persons and users who are entities. For either type of user, that data might include (a) a user profile, (b) posts made by the user to a stream associated with the profile, and (c) access control lists (ACLs) and associated GUI widgets (e.g., implementing drag-and-drop functionality) which control access rights to the stream.

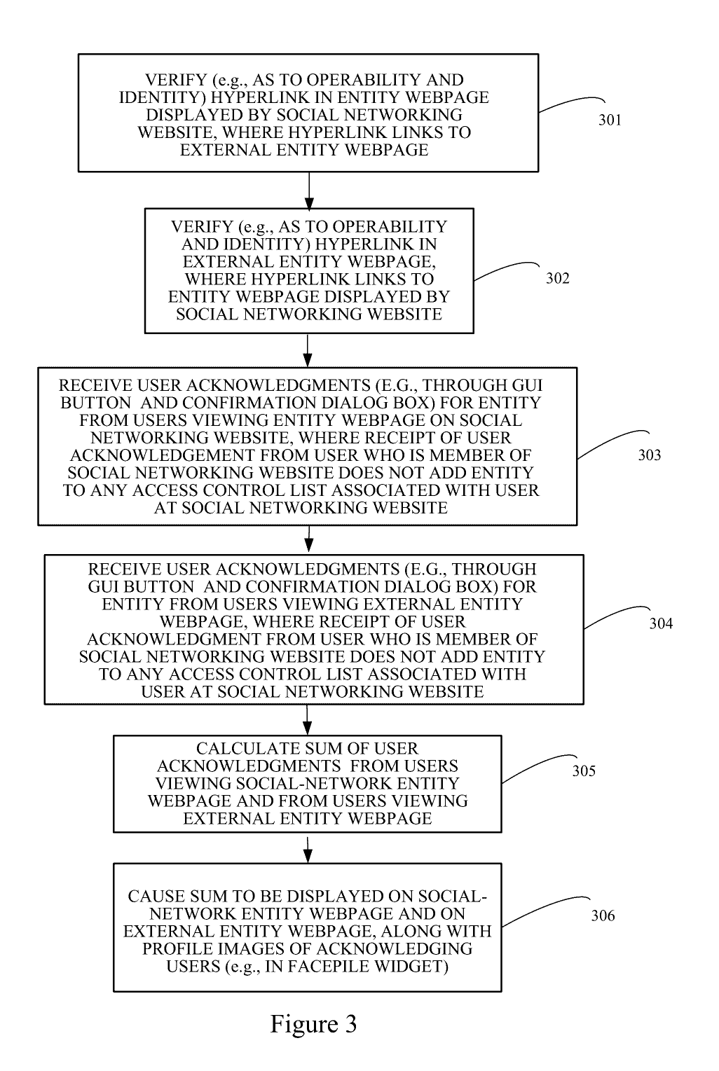

FIG. 3 is a flowchart diagram of a process for displaying a user-acknowledgement count on a social networking webpage and an entity webpage, in accordance with an example embodiment. In an example embodiment, one or more of the operations in this process might be performed by software running on the servers at website 104, e.g., frontend 202 and backend processor 203. Other operations might be performed by client software running on personal computer 102 or mobile device 103, e.g., web browser or app 201.

As depicted in FIG. 3, the software (e.g., running on servers at website 104) verifies a hyperlink in an entity webpage displayed by a social networking website, in operation 301. The hyperlink links to an external entity webpage for an entity such as an online retailer that engages in promotional activities. In an example embodiment, verification of the hyperlink might include a verification as to: (1) operability, e.g., the URL associated with the hyperlink is functional and loads the external entity webpage; and/or (2) identity, e.g., the external entity webpage is owned or controlled by the entity. In an example embodiment, verification as to identity might include parsing the URL to obtain a host and checking the host against an internal or external lookup table. Alternatively, verification as to identity might include transmitting the URL to a human verifier (e.g., on staff at the social networking website or working on a piecemeal basis through a crowdsourcing marketplace) and receiving a positive indication, e.g., as part of an online active learning system or other machine learning system. In another example embodiment, verification as to identity might make use of computer security software, e.g., anti-phishing software.

In other example embodiments, verification as to identity might be accomplished by verifying the hosting on the external website of a file specified by the social networking website. Or the software running on the social networking website might receive verification as to identity from an Interactive Voice Response (IVR) system or some similar automated system that receives a PIN that is entered by the entity that owns or controls the social-network entity webpage. In another alternative example embodiment, verification as to identity might be accomplished through automated analysis of the content (including anchor, title, text, etc.) of the social-network entity webpage, the external entity webpage, or other webpages, possibly in conjunction with other web signals and/or search signals. Or verification as to identity might be accomplished through automated analysis of data maintained by software running on the social networking website, e.g., profiles for the social-network entity webpage and other users (e.g., real persons and/or entities), postings to the streams associated with those profiles, and/or social signals such as mentions that are associated with those postings.

In operation 302, the software performs a similar verification as to operability and identity on a hyperlink in the external entity webpage. This hyperlink links to the entity webpage displayed by the social network website. It will be appreciated that the two hyperlinks described in operations 301 and 302 form a bi-directional hyperlink between an entity webpage displayed by the social networking website and an external entity webpage. Here again, verification of the hyperlink might include a verification as to: (1) operability, e.g., the URL associated with the hyperlink is functional and loads the social-network entity webpage; and/or (2) identity, e.g., the social-network entity webpage is owned or controlled by the entity.

In operation 303, the software receives user acknowledgements for the entity (e.g., an online retailer) from users viewing the entity webpage displayed by the social networking website. In an example embodiment, the user acknowledgement might result from a user clicking on a GUI button as described above. Further, the click might cause a confirmation dialog box to appear, indicating to the user that the user is acknowledging the entity, not the webpage that the user is viewing. In an alternative example embodiment, the entity webpage itself might indicate that clicking on the GUI button results in a user acknowledgement for the entity rather than the webpage that the user is viewing. Or a tooltip widget might indicate that clicking on the GUI button results in a user acknowledgement for the entity rather than the webpage that the user is viewing. In any case, receipt of a user acknowledgement from a user who is member of social networking website does not add the entity to any access control list (ACL) associated with the user at the social networking website. However, in an example embodiment, the confirmation dialog box described above or another dialog box might allow the user to add the entity to such an ACL.

In operation 304, the software receives user acknowledgements for the entity (e.g., an online retailer) from users viewing the external entity webpage (e.g., the webpage displayed by an online retailer). Here again, in an example embodiment, the user acknowledgement might result from a user clicking on a GUI button as described above. Further, the click might cause a confirmation dialog box to appear, indicating to the user that the user is acknowledging the entity, not the webpage that the user is viewing. In an alternative example embodiment, the webpage itself might indicate that clicking on the GUI button results in a user acknowledgement for the entity rather than the webpage that the user is viewing. Or a tooltip widget might indicate that clicking on the GUI button results in a user acknowledgement for the entity rather than the webpage that the user is viewing. In any case, receipt of a user acknowledgement from a user who is member of social networking website does not add the entity to any access control list (ACL) associated with the user at the social networking website. However, in an example embodiment, the confirmation dialog box described above or another dialog box might allow the user to add the entity to such an ACL.

In operation 305, the software calculates a sum of user acknowledgements from users viewing the social-network entity webpage and from users viewing the external entity webpage (e.g., displayed by an online retailer). Then in operation 306, the software causes the sum to be displayed on the social-network entity webpage and on the external entity webpage, e.g., through a transmission to a web browser displaying one of the webpages. In an example, the sum might be displayed along with profile images of the acknowledging users, using a GUI widget, on either the social-network entity webpage, the external entity webpage, or both webpages.

In an example embodiment, user acknowledgements might include both approving user acknowledgements and disapproving user acknowledgements. In such an embodiment, the sum calculated in operation 305 might involve treating approving user acknowledgements as positive values in the sum and treating disapproving user acknowledgements as negative values in the sum.

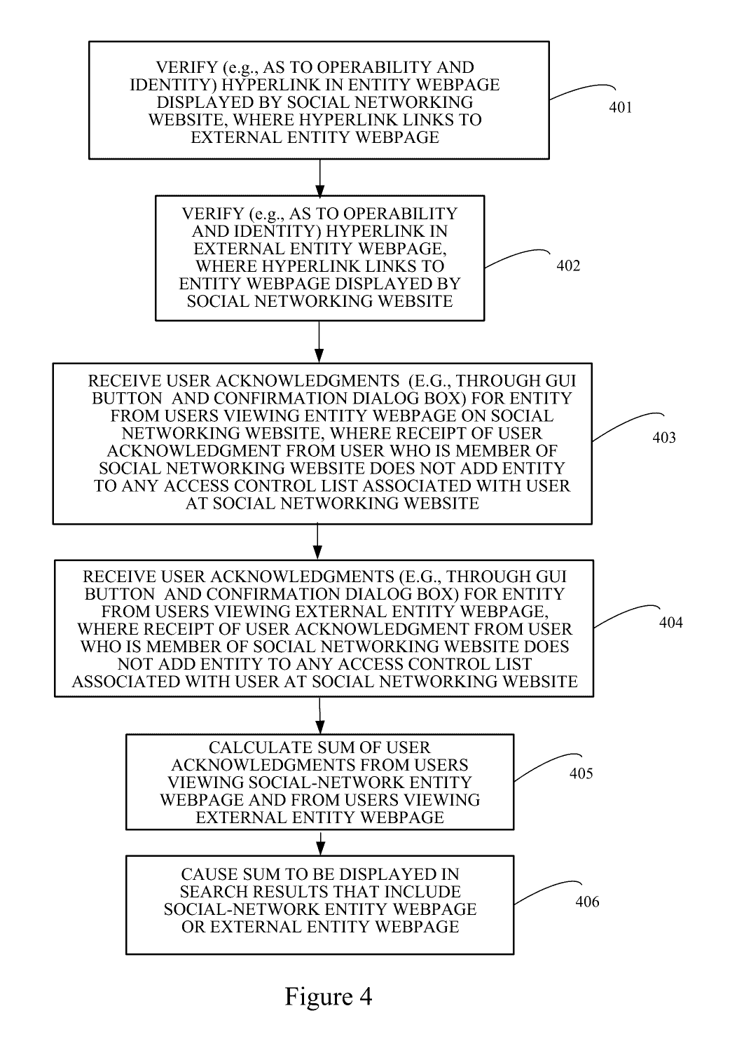

FIG. 4 is a flowchart diagram of a process for displaying a user acknowledgement count in search results, in accordance with an example embodiment. In an example embodiment, one or more of the operations in this process might be performed by software running on the servers at website 104, e.g., frontend 202 and backend processor 203. Other operations might be performed by client software running on personal computer 102 or mobile device 103, e.g., web browser or app 201.

As depicted in FIG. 4, the software (e.g., running on servers at website 104) verifies a hyperlink in an entity webpage displayed by a social networking website, in operation 401. The hyperlink links to an external entity webpage for an entity such as an online retailer that engages in promotional activities. In an example embodiment, verification of the hyperlink might include a verification as to: (1) operability, e.g., the URL associated with the hyperlink is functional and loads the external entity webpage; and/or (2) identity, e.g., the external entity webpage is owned or controlled by the entity. In an example embodiment, verification as to identity might include parsing the URL to obtain a host and checking the host against an internal or external lookup table. Alternatively, verification as to identity might include transmitting the URL to a human verifier (e.g., on staff at the social networking website or working on a piecemeal basis through a crowdsourcing marketplace) and receiving a positive indication, possibly as part of an online active learning system or other machine learning system. In another example embodiment, verification as to identity might make use of computer security software, e.g., anti-phishing software.

In other example embodiments, verification as to identity might be accomplished by verifying the hosting on the external website of a file specified by the social networking website. Or the software running on the social networking website might receive verification as to identity from an Interactive Voice Response (IVR) system or some similar automated system that receives a PIN that is entered by the entity that owns or controls the social-network entity webpage. In another alternative example embodiment, verification as to identity might be accomplished through automated analysis of the content (including anchor, title, text, etc.) of the social-network entity webpage, the external entity webpage, or other webpages, possibly in conjunction with other web signals and/or search signals. Or verification as to identity might be accomplished through automated analysis of data maintained by software running on the social networking website, e.g., profiles for the social-network entity webpage and other users (e.g., real persons and/or entities), postings to the streams associated with those profiles, and/or social signals such as mentions that are associated with those postings.

In operation 402, the software performs a similar verification as to operability and identity on a hyperlink in the external entity webpage. This hyperlink links to the entity webpage displayed by the social network website. It will be appreciated that the two hyperlinks described in operations 401 and 402 form a bi-directional hyperlink between an entity webpage displayed by the social networking website and an external entity webpage. Here again, verification of the hyperlink might include a verification as to: (1) operability, e.g., the URL associated with the hyperlink is functional and loads the social-network entity webpage; and/or (2) identity, e.g., the social-network entity webpage is owned or controlled by the entity.

In operation 403, the software receives user acknowledgements for the entity (e.g., an online retailer) from users viewing the entity webpage displayed by the social networking website. In an example embodiment, the user acknowledgement might result from a user clicking on a GUI button as described above. Further, the click might cause a confirmation dialog box to appear, indicating to the user that the user is acknowledging the entity, not the webpage that the user is viewing. In an alternative example embodiment, the entity webpage itself might indicate that clicking on the GUI button results in a user acknowledgement for the entity rather than the webpage that the user is viewing. Or a tooltip widget might indicate that clicking on the GUI button results in a user acknowledgement for the entity rather than the webpage that the user is viewing. In any case, receipt of a user acknowledgement from a user who is member of social networking website does not add the entity to any access control list (ACL) associated with the user at the social networking website. However, in an example embodiment, the confirmation dialog box described above or another dialog box might allow the user to add the entity to such an ACL.

In operation 404, the software receives user acknowledgements for the entity (e.g., an online retailer) from users viewing the external entity webpage (e.g., the webpage displayed by an online retailer). Here again, in an example embodiment, the user acknowledgement might result from a user clicking on a GUI button as described above. Further, the click might cause a confirmation dialog box to appear, indicating to the user that the user is acknowledging the entity, not the webpage that the user is viewing. In an alternative example embodiment, the webpage itself might indicate that clicking on the GUI button results in a user acknowledgement for the entity rather than the webpage that the user is viewing. Or a tooltip widget might indicate that clicking on the GUI button results in a user acknowledgement for the entity rather than the webpage that the user is viewing. In any case, receipt of a user acknowledgement from a user who is member of social networking website does not add the entity to any access control list (ACL) associated with the user at the social networking website. However, in an example embodiment, the confirmation dialog box described above or another dialog box might allow the user to add the entity to such an ACL.

In operation 405, the software calculates a sum of user acknowledgements from users viewing the social-network entity webpage and from users viewing the external entity webpage (e.g., displayed by an online retailer). Then in operation 406, the software causes the sum to be displayed in search results that include the social-network entity webpage and/or the external entity webpage. In an example embodiment, the search results might be displayed by the social networking website, when a user enters a query in an edit box associated with search functionality on the social-network entity webpage. In an alternative example embodiment, the search results might be displayed by a search engine website, when a user enters a query in an edit box associated with search functionality on a webpage displayed by the search engine website.

In an example embodiment, user acknowledgements might include both approving user acknowledgements and disapproving user acknowledgements. In such an embodiment, the sum calculated in operation 405 might involve treating approving user acknowledgements as positive values in the sum and treating disapproving user acknowledgements as negative values in the sum.

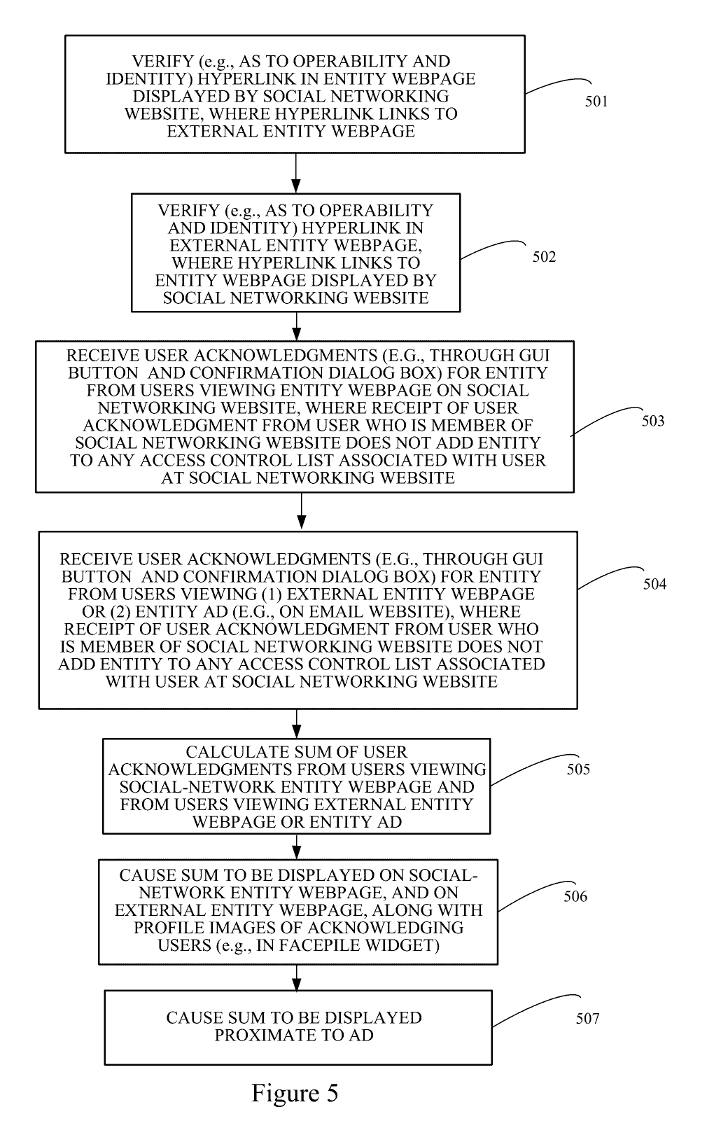

FIG. 5 is a flowchart diagram of a process for displaying a user-acknowledgement count proximate to an ad, in accordance with an example embodiment. In an example embodiment, one or more of the operations in this process might be performed by software running on the servers at website 104, e.g., frontend 202 and backend processor 203. Other operations might be performed by client software running on personal computer 102 or mobile device 103, e.g., web browser or app 201.

As depicted in FIG. 5, the software (e.g., running on servers at website 104) verifies a hyperlink in an entity webpage displayed by a social networking website, in operation 501. The hyperlink links to an external entity webpage for an entity such as an online retailer that engages in promotional activities. In an example embodiment, verification of the hyperlink might include a verification as to: (1) operability, e.g., the URL associated with the hyperlink is functional and loads the external entity webpage; and/or (2) identity, e.g., the external entity webpage is owned or controlled by the entity. In an example embodiment, verification as to identity might include parsing the URL to obtain a host and checking the host against an internal or external lookup table. Alternatively, verification as to identity might include transmitting the URL to a human verifier (e.g., on staff at the social networking website or working on a piecemeal basis through a crowdsourcing marketplace) and receiving a positive indication, possibly as part of an online active learning system or other machine learning system. In another example embodiment, verification as to identity might make use of computer security software, e.g., anti-phishing software.

In other example embodiments, verification as to identity might be accomplished by verifying the hosting on the external website of a file specified by the social networking website. Or the software running on the social networking website might receive verification as to identity from an Interactive Voice Response (IVR) system or some similar automated system that receives a PIN that is entered by the entity that owns or controls the social-network entity webpage. In another alternative example embodiment, verification as to identity might be accomplished through automated analysis of the content (including anchor, title, text, etc.) of the social-network entity webpage, the external entity webpage, or other webpages, possibly in conjunction with other web signals and/or search signals. Or verification as to identity might be accomplished through automated analysis of data maintained by software running on the social networking website, e.g., profiles for the social-network entity webpage and other users (e.g., real persons and/or entities), postings to the streams associated with those profiles, and/or social signals such as mentions that are associated with those postings.

In operation 502, the software performs a similar verification as to operability and identity on a hyperlink in the external entity webpage. This hyperlink links to the entity webpage displayed by the social network website. It will be appreciated that the two hyperlinks described in operations 501 and 502 form a bi-directional hyperlink between an entity webpage displayed by the social networking website and an external entity webpage. Here again, verification of the hyperlink might include a verification as to: (1) operability, e.g., the URL associated with the hyperlink is functional and loads the social-network entity webpage; and/or (2) identity, e.g., the social-network entity webpage is owned or controlled by the entity.

In operation 503, the software receives user acknowledgements for the entity (e.g., an online retailer) from users viewing the entity webpage displayed by the social networking website. In an example embodiment, the user acknowledgement might result from a user clicking on a GUI button as described above. Further, the click might cause a confirmation dialog box to appear, indicating to the user that the user is acknowledging the entity, not the webpage that the user is viewing. In an alternative example embodiment, the entity webpage itself might indicate that clicking on the GUI button results in a user acknowledgement for the entity rather than the webpage that the user is viewing. Or a tooltip widget might indicate that clicking on the GUI button results in a user acknowledgement for the entity rather than the webpage that the user is viewing. In any case, receipt of a user acknowledgement from a user who is member of social networking website does not add the entity to any access control list (ACL) associated with the user at the social networking website. However, in an example embodiment, the confirmation dialog box described above or another dialog box might allow the user to add the entity to such an ACL.

In operation 504, the software receives user acknowledgements for the entity (e.g., an online retailer) from users viewing (1) the external entity webpage (e.g., the webpage displayed by an online retailer) or (2) an entity ad (e.g., an ad that promotes the entity). In an example embodiment, the entity ad might be presented as a display ad in a webpage displayed by an email website, proximate to a GUI button as described above. Here again, in an example embodiment, the user acknowledgement might result from a user clicking on a GUI button as described above. Further, the click might cause a confirmation dialog box to appear, indicating to the user that the user is acknowledging the entity, not the webpage or ad that the user is viewing. In an alternative example embodiment, the webpage itself might indicate that clicking on the GUI button results in a user acknowledgement for the entity rather than the webpage or ad that the user is viewing. Or a tooltip widget might indicate that clicking on the GUI button results in a user acknowledgement for the entity rather than the webpage or ad that the user is viewing. In any case, receipt of a user acknowledgement from a user who is member of social networking website does not add the entity to any access control list (ACL) associated with the user at the social networking website. However, in an example embodiment, the confirmation dialog box described above or another dialog box might allow the user to add the entity to such an ACL.

In operation 505, the software calculates a sum of user acknowledgements from users viewing the social-network entity webpage, from users viewing the external entity webpage (e.g., displayed by an online retailer), and users viewing the ad. Then in operation 506, the software causes the sum to be displayed on the social-network entity webpage and on the external entity webpage, e.g., through a transmission to a web browser displaying one of the webpages. In an example, the sum might be displayed along with profile images of the acknowledging users, on the social-network entity webpage, the external entity webpage, or both webpages. And in operation 507, the software causes the sum to be displayed proximate to the ad, e.g., through a transmission to a web browser displaying the webpage with the ad.

In an example embodiment, user acknowledgements might include both approving user acknowledgements and disapproving user acknowledgements. In such an embodiment, the sum calculated in operation 505 might involve treating approving user acknowledgements as positive values in the sum and treating disapproving user acknowledgements as negative values in the sum.

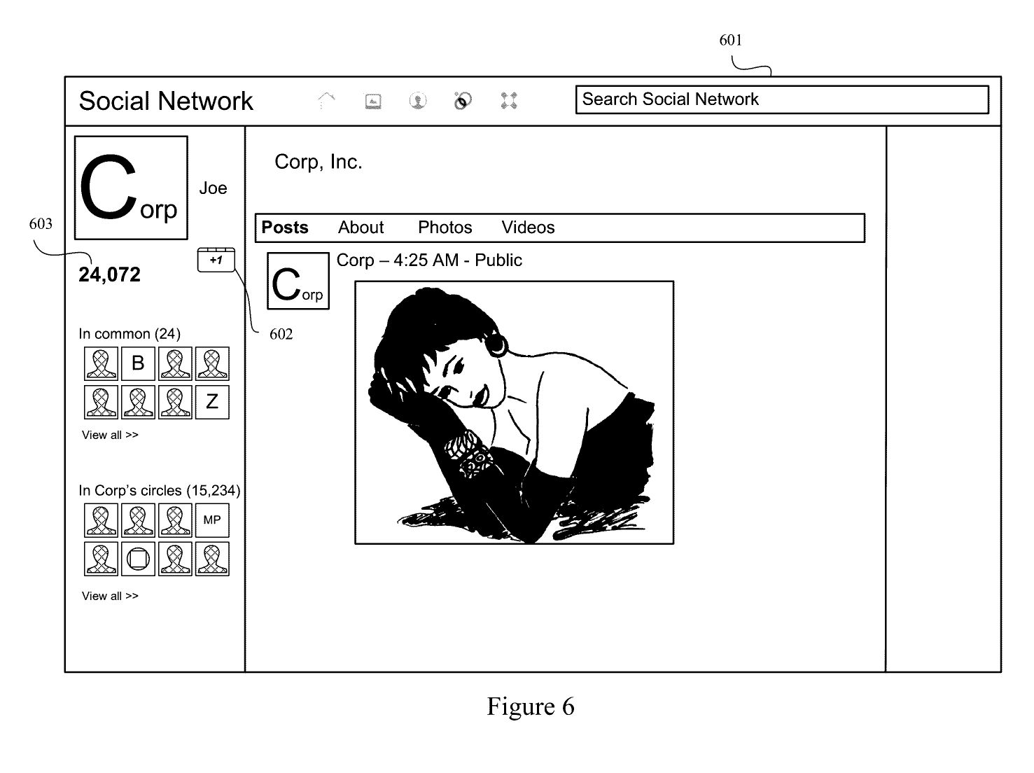

FIG. 6 shows an entity webpage displayed by a social networking website, in accordance with an example embodiment. As depicted in this figure, entity webpage 601 is a webpage created by or on behalf of an entity (e.g., an online retailer), using text, images, video, sound, etc., which promote the entity. It will be appreciated that entity webpage 601 is displayed by the social networking website. It is not displayed by the entity's website, e.g., online_retailer.com. It will be appreciated that entity webpage 601 corresponds to the social-network entity webpage described in operations 301 and 303, 401 and 403, and 501 and 503. The landing webpage at the entity's website (e.g., online_retailer.com) might correspond to the external entity webpage described in operations 302 and 304, 402 and 404, and 502 and 504.

As shown in FIG. 6, entity webpage 601 includes a GUI button 602 which allows a user to acknowledge (e.g., “+1”) the entity (e.g., an online_retailer). Entity webpage 601 also includes a count 603 of the number of user acknowledgements that the entity has received. As explained in detail above, count 603 will reflect clicks on the GUI button 603 and clicks on similar GUI buttons (e.g., GUI buttons that allow for user acknowledgement of the entity, as opposed to a webpage) on webpages displayed by the entity (e.g., at online_retailer.com). In an example embodiment, count 603 might also reflect clicks on similar buttons (e.g., GUI buttons that allow for user acknowledgement of the entity, as opposed to a webpage) proximate to an entity ad, e.g., on a webpage displayed by an email website.

With the above embodiments in mind, it should be understood that the disclosures might employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the disclosures are useful machine operations. The disclosures also relate to a device or an apparatus for performing these operations. The apparatus may be specially constructed for the required purposes, such as the carrier network discussed above, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The disclosures can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, DVDs, Flash, magnetic tapes, and other optical and non-optical data storage devices. The computer readable medium can also be distributed over a network coupled computer systems so that the computer readable code is stored and executed in a distributed fashion.

Although example embodiments of the disclosures have been described in some detail for purposes of clarity of understanding, it will be apparent that certain changes and modifications can be practiced within the scope of the following claims. For example, the entity webpage displayed by a social networking website might be replaced by an entity webpage displayed by a social media website. Furthermore, the operations described above can be ordered, modularized, and/or distributed in any suitable way. Accordingly, the present embodiments are to be considered as illustrative and not restrictive, and the disclosures are not to be limited to the details given herein, but may be modified within the scope and equivalents of the following claims. In the following claims, elements and/or steps do not imply any particular order of operation, unless explicitly stated in the claims or implicitly required by the disclosure.

What is claimed is:

1. A method comprising:
receiving acknowledgments for an entity at a first resource that is provided through a social networking service, each acknowledgement for the entity at the first resource corresponding to user feedback for the entity provided at the first resource;
determining that a link included in the first resource provided through the social networking service identifies a second resource that is external to the social networking service;
receiving acknowledgments for the entity at the second resource that is external to the social networking service, each acknowledgment for the entity at the second resource corresponding to user feedback for the entity provided at the second resource;
combining, by a processor, a count of the acknowledgments received for the entity at the first resource and a count of the acknowledgments received for the entity at the second resource to calculate a sum of the acknowledgments received for the entity at the first resource and the second resource; and
providing the sum of the acknowledgements received for the entity at the first and second resources and an identification of at least one user associated with the acknowledgments for the entity at the first and second resources for display on the first resource and the second resource, wherein receipt of at least one of the acknowledgements from a user who is a member of the social networking service does not add the entity to any access control list associated with the user at the social networking service.

2. (canceled)

3. The method of claim 1, wherein the first resource is a first webpage and the second resource is a second webpage.

4. The method of claim 3, wherein the acknowledgements for the entity at the first and second resources are received through a graphical user interface (GUI) button on the first or second webpages.

5. The method of claim 4, wherein at least one of the acknowledgements is confirmed with a GUI dialog box indicating that a user is acknowledging the entity and not acknowledging the first or second webpage being viewed by the user, the GUI dialog box being provided in response to receiving the at least one of the acknowledgments for the entity.

6. The method of claim 1, the method further comprising:
verifying the link in the first resource, wherein the link connects to the second resource; and
verifying a second link in the second resource, wherein the second link connects to the first resource, and wherein verifying the link includes determining that the link is operational to load the second resource and wherein verifying the second link includes determining that the second link is operational to load the first resource, and that the second resource connected by the link is owned or controlled by the entity by parsing the link that connects to the second resource to identify a host and checking the host against a lookup table.

7. The method of claim 3, further comprising providing an image associated with the user who makes at least one of the acknowledgements, wherein the image is displayed on the first webpage, the second webpage, or both webpages.

8. The method of claim 3, further comprising providing the sum of the acknowledgements for the entity at the first and second resources for display in any search results that include the first webpage or the second webpage.

9. A non-transitory computer readable storage medium storing instructions, wherein the instructions, when executed by a processor, instruct the processor to perform the following operations:
receive acknowledgments for an entity at a first resource that is provided through a social networking service, each acknowledgement for the entity at the first resource corresponding to user feedback for the entity provided at the first resource;
determine that a link included in the first resource provided through the social networking service identifies a second resource that is external to the social networking service
receive acknowledgments for the entity at the second resource that is external to the social networking service, each acknowledgment for the entity at the second resource corresponding to user feedback for the entity provided at the second resource;
combine a count of the acknowledgments received for the entity at the first resource and a count of the acknowledgments received for the entity at the second resource to calculate a sum of the acknowledgments received for the entity at the first resource and the second resource; and
provide the sum of the acknowledgements received for the entity at the first and second resources and an identification of at least one user associated with the acknowledgments for the entity at the first and second resources for display on the first resource and the second resource, wherein receipt of at least one of the acknowledgements from a user who is a member of the social networking service does not add the entity to any access control list associated with the user at the social networking service.

10. (canceled)

11. The non-transitory computer readable storage medium of claim 9, wherein the first resource is a first webpage and the second resource is a second webpage.

12. The non-transitory computer readable storage medium of claim 11, wherein the acknowledgements for the entity at the first and second resources are received through a graphical user interface (GUI) button on the first or second webpages.

13. The non-transitory computer readable storage medium of claim 12, wherein at least one of the acknowledgements is confirmed with a GUI dialog box indicating that a user is acknowledging the entity and not acknowledging the first or second webpage being viewed by the user, the GUI dialog box being provided in response to receiving the at least one of the acknowledgments for the entity.

14. The non-transitory computer readable storage medium of claim 9, the operations further comprising:
verifying the link in the first resource, wherein the link connects to the second resource; and
verifying a second link in the second resource, wherein the second link connects to the first resource, and wherein verifying the link includes determining that the link is operational to load the second resource and wherein verifying the second link includes determining that the second link is operational to load the first resource, and that the second resource connected by the link is owned or controlled by the entity by parsing the link that connects to the second resource to identify a host and checking the host against a lookup table.

15. The non-transitory computer readable storage medium of claim 11, wherein the operations further comprise providing an image associated with the user who makes at least one of the acknowledgements, wherein the image is displayed on the first webpage, the second webpage, or both webpages.

16. The non-transitory computer readable storage medium of claim 11, wherein the operations further comprise providing the sum of the acknowledgments for the entity at the first and second resources for display in any search results that include the first webpage or the second webpage.

17. A method comprising:
receiving acknowledgments for an entity at a first resource that is provided through a social networking service, each acknowledgement for the entity at the first resource corresponding to user feedback for the entity provided at the first resource;
determining that a link included in the first resource provided through the social networking service identifies a second resource that is external to the social networking service;
receiving acknowledgments for the entity at the second resource that is external to the social networking service, each acknowledgment for the entity at the second resource corresponding to user feedback for the entity provided at the second resource;
receiving acknowledgements for the entity that are associated with an ad relating to the entity;
combining, by a processor, a count of the acknowledgments received for the entity at the first resource, a count of the acknowledgments received for the entity at the second resource, and a count of the acknowledgements received for the entity that are associated with the ad to calculate a sum of the acknowledgments received for the entity at the first resource, the second resource, and associated with the ad; and
providing the sum of the acknowledgements received for the entity at the first and second resources and associated with the ad and an identification of at least one user associated with the acknowledgments for the entity at the first and second resources and the ad for display on the first resource, the second resource, and proximate to the ad, wherein receipt of at least one of the acknowledgements from a user who is a member of the social networking service does not add the entity to any access control list associated with the user at the social networking service.

18. (canceled)

19. The method of claim 17, wherein the first resource is a first webpage and the second resource is a second webpage.

20. The method of claim 19, wherein the acknowledgements for the entity at the first and second resources and the acknowledgements for the entity that are associated with the ad are received through a graphical user interface (GUI) button on the first or second webpages.

21. The method of claim 1, wherein combining the count of the acknowledgements received for the entity at the first resource and the second resource to calculate the sum is based on approving acknowledgments being a positive value used in calculating the sum and disapproving acknowledgments being a negative value used in calculating the sum.
